(19) United States
(12) Patent Application Publication
(10) Pub. No.: US 2026/0318291 A1
(43) Pub. Date: Oct. 15, 2026

(54) Gamma stable composite elastomeric and thermoplastic material for pump tubing and other polymer geometries

(71) Applicant: SYNTH-BIO, LLC, Middlesex, NJ (US)

(72) Inventor: Louis BONGIORNO, Millington, NJ (US)

(73) Assignee: Contour Biosolutions, LLC, Middlesex, NJ (US)

(21) Appl. No.: 19/119,188

(22) PCT Filed: Nov. 17, 2023
(86) PCT No.: PCT/US2023/080277

§ 371 Date: Apr. 8, 2025

Related U.S. Application Data
(60) Provisional application No. 63/427,249, filed on Nov. 22, 2022.

(51) Int. Cl. F04B 43/00; B01D 69/10

(52) U.S. Cl. CPC F04B 43/0072; B01D 69/107; B01D 2325/02834

(57) ABSTRACT

An article includes a membrane and a substrate. The membrane including an elastomeric material having a membrane outer surface. The substrate including a microporous thermoplastic material and being attached to at least a portion of the membrane outer surface with a portion of the elastomeric material extending into at least a portion of the micropores. The substrate having a thickness in a range of between 0.5 μm and 12 μm. A volume ratio of the elastomeric material to the microporous thermoplastic material being in a range of between 1:1 and 100:1. The article may be in the form of a hollow tube, a gasket, a valve liner, or a valve seat.

### CROSS REFERENCES AND PRIORITIES

This Application claims priority to U.S. Provisional Application No. 63/427,249 filed on 22 Nov. 2022, the teachings of which are incorporated by reference herein in their entirety.

### BACKGROUND

Silicone elastomers can be fabricated into many forms for a variety of uses. For example, in the medical, electrical, and chemical industries. Articles such as peristaltic pump hollow tubes, pump diaphragms, bellows, baby bottle nipples, wire and cable sheaths, gaskets, and o-rings are commonly made from silicone elastomers.

Many of these articles are used in applications that require repeated flexing. For example, peristaltic pumps are used to transport liquids and pastes through an elastomeric hollow tube in which the hollow tube is squeezed between a set of rotating rollers and a fixed pump housing. Silicone elastomers are frequently used for peristaltic pump tubing. Upon repeated flexure, however, the silicone rubber tubing may develop cracks in the side wall and may rupture catastrophically.

In addition, silicone elastomers have proven difficult to sterilize for reuse. In many medical, chemical, and biological applications, it is desirably to utilize the same silicone elastomeric articles such as peristaltic pump tubing for multiple patients, manufacturing runs, or the like. To avoid contamination from patient to patient or manufacturing run to manufacturing run, the silicone elastomer article must be sterilized prior to reuse. Typical sterilization methods such as gamma radiation are known to degrade the silicone elastomer material of the article thereby increasing the likelihood of catastrophic failure during subsequent uses.

The need exists, therefore, for an improved silicone elastomer article which is resistant to cracking over time and repeated flexure and is stable during sterilization with gamma radiation.

### SUMMARY

Described herein is an article comprising a membrane and a substrate. The membrane being comprised of an elastomeric material and having a membrane outer surface. The substrate being comprised of a microporous thermoplastic material comprising a plurality of micropores. The substrate being attached to at least a portion of the membrane outer surface and having a thickness in a range of between 0.5 μm and 12 μm. A volume ratio of the elastomeric material to the microporous thermoplastic material is in a range of between 1:1 and 100:1.

In some embodiments, the elastomeric material may be selected from the group consisting of platinum silicone, fluorinated silicone, ethylene propylene diene monomer rubber (EPDM), and fluorocarbon-based fluoroelastomers.

In certain embodiments, the microporous thermoplastic material may be selected from the group consisting of a polypropylene, polyether ether ketone, polyurethane, polyethylene, and polyamide.

In some embodiments, the thickness of the substrate may be in a range selected from the group consisting of between 0.5 μm and 10 μm, between 0.5 μm and 7.5 μm, between 0.5 μm and 5.0 μm, between 1.0 μm and 12 μm, between 1.0 μm and 10 μm, between 1.0 μm and 7.5 μm, between 1.0 μm and 5.0 μm, between 2.0 μm and 12 μm, between 2.0 μm and 10 μm, between 2.0 μm and 7.5 μm, and between 2.0 μm and 5.0 μm.

In certain embodiments, the ratio of elastomeric material to microporous thermoplastic material may be in a range selected from the group consisting of between 1:1 and 75:1, between 1:1 and 50:1, between 1:1 and 25:1, between 5:1 and 100:1, between 5:1 and 75:1, between 5:1 and 50:1, between 5:1 and 25:1, between 10:1 and 100:1, between 10:1 and 75:1, between 10:1 and 50:1, and between 10:1 and 25:1.

In some embodiments, the microporous thermoplastic material may comprise a plurality of micropores having an average pore size in a range of between 0.1 μm and 15 μm. The average pore size of the micropores may also be in a range selected from the group consisting of between 0.1 μm and 10 μm, between 0.1 μm and 7.5 μm, between 0.1 μm and 5.0 μm, between 1.0 μm and 15 μm, between 1.0 μm and 10 μm, between 1.0 μm and 7.5 μm, between 1.0 μm and 5.0 μm, between 2.0 μm and 15 μm, between 2.0 μm and 10 μm, between 2.0 μm and 7.5 μm, and between 2.0 μm and 5.0 μm. A portion of the elastomeric material may extend into at least a portion of the micropores.

In certain embodiments, the article may be in the form of a hollow tube. In some such embodiments, the hollow tube may have an inside diameter in a range of between 0.5 mm and 300 mm. In other such embodiments, the hollow tube may have an inside diameter in a range selected from the group consisting of between 0.5 mm and 250 mm, between 0.5 mm and 200 mm, between 0.5 mm and 150 mm, between 0.5 mm and 100 mm, between 1.0 mm and 300 mm, between 1.0 mm and 250 mm, between 1.0 mm and 200 mm, between 1.0 mm and 150 mm, between 1.0 mm and 100 mm, between 25 mm and 300 mm, between 25 mm and 250 mm, between 25 mm and 200 mm, between 25 mm and 150 mm, between 25 mm and 100 mm, between 50 mm and 300 mm, between 50 mm and 250 mm, between 50 mm and 200 mm, between 50 mm and 150 mm, and between 50 mm and 100 mm.

In some embodiments, the article may be in the form of a gasket. In other embodiments, the article may be in the form of a valve liner. In still other embodiments, the article may be in the form of a valve seat.

### BRIEF DESCRIPTION OF FIGURES

FIG. 1 is a perspective view of an article.

FIG. 2 is a cross-section of an article.

FIG. 3 is a perspective view of an article that is a hollow tube.

FIG. 4 is a top view of an article that is a gasket.

FIG. 5 is a perspective view of an article that is a valve liner.

FIG. 6 is a perspective view of an article that is a valve seat.

### DETAILED DESCRIPTION

Disclosed herein is an article. As described herein and in the claims, the following numbers refer to the following structures as noted in the Figures.
10 refers to an article.
11 refers to a hollow tube.
12 refers to a gasket.
13 refers to a valve liner.
14 refers to a valve seat.
100 refers to a membrane.
110 refers to a membrane outer surface.
200 refers to a substrate.

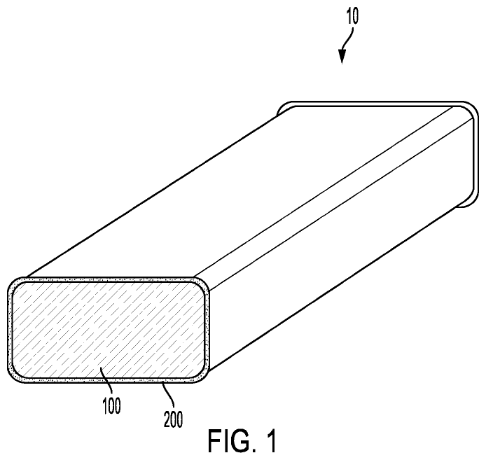

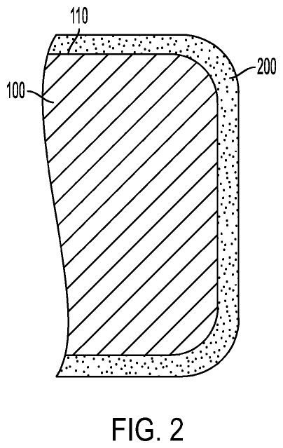

FIG. 1 shows a perspective view of an article (10) with FIG. 2 showing a cross-section thereof. As shown in FIG. 1 and FIG. 2, the article comprises a membrane (100) and a substrate (200). The membrane will have a membrane outer surface (110) and may be comprised of an elastomeric material. The substrate is attached to at least a portion of the membrane outer surface and may be comprised of a microporous thermoplastic material.

The connection between the membrane (100) and the substrate (200) may be achieved by coating the membrane to the substrate. Preferably, the substrate will have a thickness in a range selected from the group consisting of between 0.5 μm and 12 μm, between 0.5 μm and 10 μm, between 0.5 μm and 7.5 μm, between 0.5 μm and 5.0 μm, between 1.0 μm and 12 μm, between 1.0 μm and 10 μm, between 1.0 μm and 7.5 μm, between 1.0 μm and 5.0 μm, between 2.0 μm and 12 μm, between 2.0 μm and 10 μm, between 2.0 μm and 7.5 μm, and between 2.0 μm and 7.5 μm.

As the preferred manufacturing method is coating the membrane (100) to the substrate material (200), a volume ratio between the elastomeric material and the microporous thermoplastic material exists. Preferably, the ratio of the elastomeric material to the microporous thermoplastic material may be in a range of between 1:1 and 100:1, between 1:1 and 75:1, between 1:1 and 50:1, between 1:1 and 25:1, between 5:1 and 100:1, between 5:1 and 75:1, between 5:1 and 50:1, between 5:1 and 25:1, between 10:1 and 100:1, between 10:1 and 75:1, between 10:1 and 50:1, and between 10:1 and 25:1.

Any number of different elastomeric materials may be used in the membrane (100). Preferred examples of such elastomeric materials include platinum silicone, fluorinated silicone, ethylene propylene diene monomer rubber (EPDM), and fluorocarbon-based fluoroelastomers.

Any number of different microporous thermoplastic materials may be used in the substrate (200). Preferred examples of such microporous thermoplastic materials include polypropylene (PP), polyether ether ketone (PEEK), polyurethane, polyethylene (PE), and polyamide.

The plurality of micropores of the microporous thermoplastic material will have an average pore size. Preferably, the average pore size will be in a range selected from the group consisting of between 0.1 μm and 15 μm, between 0.1 μm and 10 μm, between 0.1 μm and 7.5 μm, between 0.1 μm and 5.0 μm, between 1.0 μm and 15 μm, between 1.0 μm and 10 μm, between 1.0 μm and 7.5 μm, between 1.0 μm and 5.0 μm, between 2.0 μm and 15 μm, between 2.0 μm and 10 μm, between 2.0 μm and 7.5 μm, and between 2.0 μm and 5.0 μm. Preferably, the substrate will be attached to at least a portion of the membrane outer surface in a manner such that a portion of the elastomeric material extends into at least a portion of the micropores.

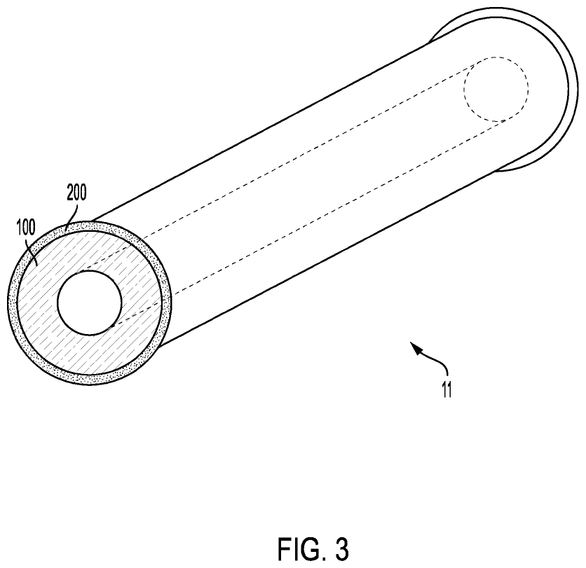

The article (10) may take many forms. For example, FIG. 3 shows the article in the form of a hollow tube (11). When the article is in the form of a hollow tube, the hollow tube may have an inside diameter in a range selected from the group consisting of between 0.5 mm and 300 mm, between 0.5 mm and 250 mm, between 0.5 mm and 200 mm, between 0.5 mm and 150 mm, between 0.5 mm and 100 mm, between 1.0 mm and 300 mm, between 1.0 mm and 250 mm, between 1.0 mm and 200 mm, between 1.0 mm and 150 mm, between 1.0 mm and 100 mm, between 25 mm and 300 mm, between 25 mm and 250 mm, between 25 mm and 200 mm, between 25 mm and 150 mm, between 25 mm and 100 mm, between 50 mm and 300 mm, between 50 mm and 250 mm, between 50 mm and 200 mm, between 50 mm and 150 mm, and between 50 mm and 100 mm.

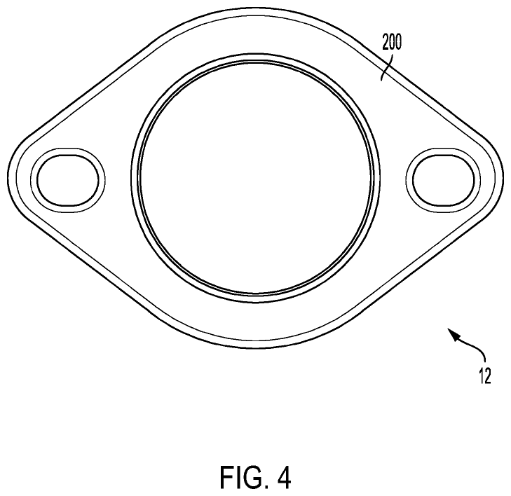

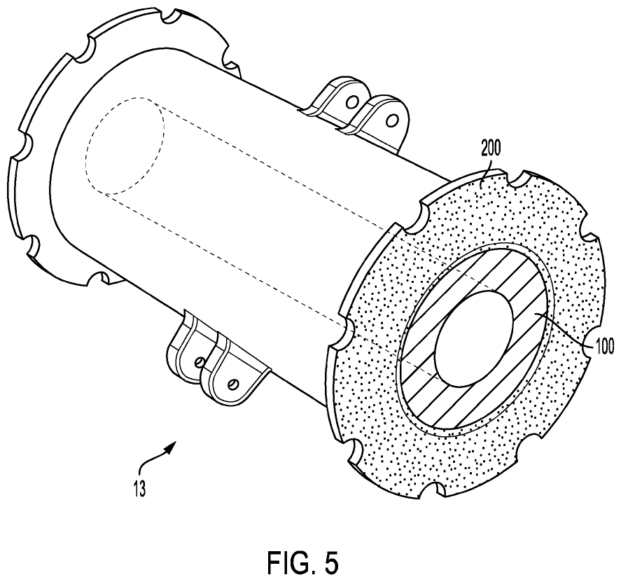

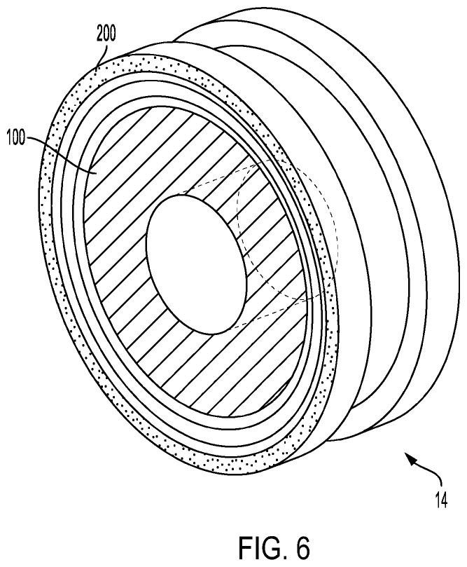

Alternatively, the article may take the form of a gasket (12) as shown in FIG. 4. The article may also take the form of a valve liner (13) as shown in FIG. 5. In some embodiments, the article may also take the form of a valve seat (14) as shown in FIG. 6. While a hollow tube, a gasket, a valve liner, and a valve seat are shown in the Figures as examples of different geometries that the article may take, a myriad of different geometries may be formed by compiling the materials into or onto one another or by wrapping, overwrapping, laying or overlaying into various geometries.

Preferably, the substrate will be manufactured first using any number of manufacturing techniques known in the art such as injection molding, thermoforming, and the like. The substrate material is preferably heat set to resist stretching in all directions.

Once the substrate is manufactured, the surface of the substrate is coated with the membrane material. Exemplary coating processes include knife over roll coating, gravure coating, roll-to-roll coating, and ultrasonic spraying. Preferably, the membrane material will be applied to at least 90% of the surface area of the substrate with at least 95% of the surface area being more preferred, at least 99% of the surface area being still more preferred, and 100% of the surface area being most preferred.

When the article is formed into a hollow tube, valve liner, or valve seat the membrane material may be adhered to the substrate material by wrapping the membrane material and an uncured mixture of the substrate material around a mandrel until a desired height (also referred to as a wall thickness) is achieved. The semi-finished product may then be placed under compression by wrapping a metal, fabric, or other semi-rigid material around the outer surface thereof before heating the semi-finished product to cure the substrate material. Heating may occur in an oven at a temperature in a range of between 140 °C and 220 °C for a time in a range of between 5 min. and 12 hours.

When the article is formed into a gasket, the substrate material may be stacked in layers to achieve a desired height (thickness) and then cut into rings sized near dimensional net size. Multiple rings may then be stacked to a desired height (thickness). The resulting structure may then be placed into a mold where the membrane material is introduced by injection, transfer, or compression methods before heating the semi-finished product to cure the substrate material. Heating may occur in an oven at a temperature in a range of between 140 °C and 220 °C for a time in a range of between 5 min. and 12 hours.

The articles disclosed herein comprised of an elastomeric membrane and a microporous thermoplastic substrate have been observed to achieve improved resistance to cracking over time and repeated flexure when compared to known silicone elastomer articles. In addition, the articles disclosed herein are gamma-stable. That is to say that the articles disclosed herein can be sterilized using gamma radiation without degrading the elastomeric material.

While the article has been described as having one or more exemplary designs, the present article may be further modified within the spirit and scope of this disclosure. This application is therefore intended to cover any variations, uses, or adaptations of the tent assembly using its general principles.

1. An article (10) comprising:
an membrane (100) comprised of an elastomeric material and having a membrane outer surface (110); and
a substrate (200) comprised of a microporous thermoplastic material comprising a plurality of micropores, said substrate attached to at least a portion of the membrane outer surface and having a thickness in a range of between 0.5 μm and 12 μm; and
wherein a volume ratio of the elastomeric material to the microporous thermoplastic material is in a range of between 1:1 and 100:1.

2. The article of claim 1, wherein the elastomeric material is selected from the group consisting of platinum silicone, fluorinated silicone, ethylene propylene diene monomer rubber (EPDM), and fluorocarbon-based fluoroelastomers.

3. The article of claim 1, wherein the microporous thermoplastic material is selected from the group consisting of a polypropylene, polyether ether ketone, polyurethane, polyethylene, and polyamide.

4. (canceled)

5. (canceled)

6. The article of claim 1, wherein the microporous thermoplastic material comprises a plurality of micropores having have an average pore size in a range of between 0.1 μm and 15 μm.

7. (canceled)

8. The article of claim 6, wherein a portion of the elastomeric material extends into at least a portion of the micropores.

9. The article of claim 1, wherein the article is in the form of a hollow tube (11).

10. The article of claim 9, wherein the hollow tube has an inside diameter in the range of between 0.5 mm and 300 mm.

11. (canceled)

12. The article of claim 1, wherein the article is in the form of a gasket (12).

13. The article of claim 1, wherein the article is in the form of a valve liner (13).

14. The article of claim 1, wherein the article is in the form of a valve seat (14).

15. The article of claim 2, wherein the microporous thermoplastic material is selected from the group consisting of a polypropylene, polyether ether ketone, polyurethane, polyethylene, and polyamide.

16. The article of claim 2, wherein the plurality of micropores have an average pore size in a range of between 0.1 μm and 15 μm.

17. The article of claim 3, wherein the plurality of micropores have an average pore size in a range of between 0.1 μm and 15 μm.

18. The article of claim 16, wherein a portion of the elastomeric material extends into at least a portion of the micropores.

19. The article of claim 17, wherein a portion of the elastomeric material extends into at least a portion of the micropores.

20. The article of claim 19, wherein the article is in the form of a hollow tube (11).

21. The article of claim 20, wherein the hollow tube has an inside diameter in the range of between 0.5 mm and 300 mm.

22. The article of claim 19, wherein the article is in the form of a gasket (12).

23. The article of claim 19, wherein the article is in the form of a valve liner (13).

24. The article of claim 19, wherein the article is in the form of a valve seat (14).
